(19) United States
(12) Patent Application Publication
(10) Pub. No.: US 2018/0212470 A1
(43) Pub. Date: Jul. 26, 2018

(54) WIRELESSLY CHARGING BATTERY AND WIRELESS CHARGING CONTROL METHOD

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 15/742,724

(22) PCT Filed: Jun. 20, 2016
(86) PCT No.: PCT/KR2016/006527

§ 371 Date: Jan. 8, 2018

(30) Foreign Application Priority Data
Aug. 24, 2015 (KR) 10-2015-0118777

(51) Int. Cl. H02J 50/12; H02J 7/02; H02J 7/00

(52) U.S. Cl. CPC H02J 50/12; H02J 2007/005; H02J 7/0047; H02J 7/025

(57) ABSTRACT

The present invention relates to a wirelessly charging battery and a wireless charging control method thereof, the wireless charging control method of the wirelessly charging battery that may be mounted on an electronic device, according to one embodiment of the present invention, comprising the steps of: calculating a battery charge level of the wirelessly charging battery; switching from an operation mode of the wirelessly charging battery to a receiver mode if the calculated battery charge level is lower than a preset receiver mode threshold value; searching a wireless power transmission device if switched to the receiver mode; and charging the battery by receiving a power signal from the searched wireless power transmission device. Thus, the present invention has a merit of providing a wirelessly charging battery which is attached/detached to an electronic device, and which may adaptively control an operation mode according to the charge level of the battery.

### TECHNICAL FIELD

Embodiments relate to a wireless charging technology, and more particularly, to a wirelessly charged battery capable of adaptively controlling an operation mode based on a battery charging level and supplying power to an electronic device, and a charging control method in the wirelessly charged battery.

### BACKGROUND ART

Recently, as information and communication technology rapidly develops, a ubiquitous society based on information and communication technology is being formed.

In order for information communication devices to be connected anywhere and anytime, sensors equipped with a computer chip having a communication function should be installed in all facilities throughout society. Accordingly, power supply to these devices or sensors is becoming a new challenge. In addition, as the types of mobile devices such as Bluetooth handsets and iPods, as well as mobile phones, rapidly increase in number, charging the battery has required time and effort. As a way to address this issue, wireless power transmission technology has recently drawn attention.

Wireless power transmission (or wireless energy transfer) is a technology for wirelessly transmitting electric energy from a transmitter to a receiver using the induction principle of a magnetic field. Back in the 1800s, an electric motor or a transformer based on the electromagnetic induction principle began to be used. Thereafter, a method of transmitting electric energy by radiating an electromagnetic wave such as a radio wave or laser was tried. Electric toothbrushes and some wireless shavers are charged through electromagnetic induction.

Up to now, wireless energy transmission schemes may be broadly classified into electromagnetic induction, electromagnetic resonance, and RF transmission using a short-wavelength radio frequency.

In the electromagnetic induction scheme, when two coils are arranged adjacent to each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, the device should be generally arranged adjacent to the charger or the floor.

The electromagnetic resonance scheme uses an electric field or a magnetic field instead of using an electromagnetic wave or current. The electromagnetic resonance scheme is advantageous in that the scheme is safe to other electronic devices or the human body since it is hardly influenced by the electromagnetic wave. However, this scheme may be used only at a limited distance and in a limited space, and has somewhat low energy transfer efficiency.

The short-wavelength wireless power transmission scheme (simply, RF transmission scheme) takes advantage of the fact that energy can be transmitted and received directly in the form of radio waves. This technology is an RF power transmission scheme using a rectenna. A rectenna, which is a compound of antenna and rectifier, refers to a device that converts RF power directly into direct current (DC) power. That is, the RF method is a technology for converting AC radio waves into DC waves. Recently, with improvement in efficiency, commercialization of RF technology has been actively researched.

The wireless power transmission technology is applicable to various industries including IT, railroads, and home appliance industries as well as the mobile industry.

Batteries mounted in conventional small home appliances and lighting equipment are consumables that are discarded after they are used for a certain period of time or rechargeable batteries that can be recharged using a charging device connected to a separate power terminal.

Recently, portable rechargeable auxiliary batteries for charging smartphone batteries have been actively distributed. The portable rechargeable auxiliary battery is connected to an external power source through a built-in micro USB port and a standard USB port to charge the internal chargeable battery and the smartphone battery is supplied with power by directly connecting the smartphone to a provided lightning slot.

However, charging small electronic devices such as a smartphone using the portable auxiliary battery as mentioned above always requires a portable auxiliary battery to be charged in advance, and requires users to always carry the portable auxiliary battery, thereby causing inconvenience.

Particularly, the battery applied to toy products is either a rechargeable battery or a disposable battery, and the user needs to charge the rechargeable battery using a separate charging device or replace the disposable battery with a new one when the battery of the toy product is dead, thereby experiencing inconvenience.

Therefore, the conventional charging method for batteries of small home appliances and toys not only causes inconvenience to the user but also damages the environment due to excessive use of disposable batteries.

### DISCLOSURE

### Technical Problem

Therefore, the present disclosure has been made in view of the above problems, and embodiments provide a wirelessly charged battery capable of being charged by wirelessly receiving power.

Embodiments further provide a battery type wireless power reception apparatus capable of being automatically charged wirelessly without using a separate charging device and a portable auxiliary battery.

Embodiments further provide a wireless charging control method capable of adaptively controlling an operation mode according to a battery charging level and a wirelessly charged battery therefor.

The technical objects that can be achieved through the embodiments are not limited to what has been particularly described hereinabove and other technical objects not described herein will be more clearly understood by persons skilled in the art from the following detailed description.

### TECHNICAL SOLUTION

The present disclosure may provide a wireless charging battery and a wireless charging control method therefor.

In one embodiment, a wireless charging control method in a wirelessly charged battery mountable in an electronic device may include calculating a battery charging level of the wirelessly charged battery, switching an operation mode of the wirelessly charged battery to a receiver mode when the calculated battery charging level is lower than a predetermined receiver mode threshold, searching for a wireless power transmission apparatus when the operation mode is switched to the receiver mode, and receiving a power signal from the discovered wireless power transmission apparatus and charging the battery.

The calculating of the battery charging level may include measuring a battery output voltage intensity of the wirelessly charged battery, and calculating the battery charging level based on the measured battery output voltage intensity.

The search for the wireless power transmission apparatus may include searching for a wireless power transmission apparatus supporting a first wireless power transmission scheme, and searching for a wireless power transmission apparatus supporting a second wireless power transmission scheme when the search for the wireless power transmission apparatus supporting the first wireless power transmission scheme fails.

Each of the first wireless power transmission scheme and the second wireless power transmission scheme may be one of an electromagnetic resonance scheme and an electromagnetic induction scheme.

The method may further include switching the operation mode of the wirelessly charged battery from the receiver mode to a transmitter mode when the battery charging level calculated in the receiver mode exceeds a predetermined transmitter mode threshold.

The method may further include searching for a wireless power reception apparatus when the operation mode is switched to the transmitter mode, and transmitting a power signal to the discovered wireless power reception apparatus using power charged in the battery.

The method may further include returning to the search for the wireless power transmission apparatus when the search for the wireless power reception apparatus fails in the transmitter mode.

When power greater than or equal to a predetermined reference value is supplied to the electronic device in the transmitter mode, the operation mode may be switched to the receiver mode.

The method may further include collecting information about a battery charging level of an adjacent wirelessly charged battery connected in parallel or in series with the wirelessly charged battery, wherein, when the battery charging level of the wirelessly charged battery exceeds the battery charging level of the adjacent wirelessly charged battery, the operation mode may be switched to the transmitter mode, and the adjacent wirelessly charged battery may be charged using power charged in the battery.

The calculating of the battery charging level may include measuring a temperature of a resistance element connected to a positive terminal of the wirelessly charged battery, and calculating the battery charging level based on the measured temperature.

In another embodiment, a wirelessly charged battery mountable in an electronic device may include a core having magnetism, a coil surrounding an outer periphery of the core, a wireless power reception unit configured to convert alternating current (AC) power received through the coil into direct current (DC) power and supply the DC power to a load, a sensing unit configured to measure an output voltage intensity of the load, and a controller configured to calculate a battery charging level based on the output voltage intensity of the load and to switch an operation mode of the wirelessly charged battery to a receiver mode and search for a wireless power transmission apparatus to receive a power signal when the calculated battery charging level is lower than a predetermined receiver mode threshold.

The wirelessly charged battery may be connected in parallel or in series with at least one slave wirelessly charged battery through a predetermined connection means, wherein the controller may communicate with the discovered wireless power transmission apparatus as a master to control the at least one slave wirelessly charged battery to be wirelessly charged.

When a search for a wireless power transmission apparatus supporting a first wireless power transmission scheme fails, the controller may search for a wireless power transmission apparatus supporting a second wireless power transmission scheme.

Each of the first wireless power transmission scheme and the second wireless power transmission scheme may be one of an electromagnetic resonance scheme and an electromagnetic induction scheme.

When the battery charging level calculated in the receiver mode exceeds a predetermined transmitter mode threshold, the controller may switch the operation mode of the wirelessly charged battery from the receiver mode to a transmitter mode.

The wirelessly charged battery may further include a wireless power transmission unit configured to transmit a power signal under control of the controller in the transmitter mode, wherein, when the operation mode is switched to the transmitter mode, the controller may search for a wireless power reception apparatus, and control power charged in the battery to be transmitted to the discovered wireless power reception apparatus through the wireless power transmission unit.

When the search for the wireless power reception apparatus fails in the transmitter mode, the controller may switch the operation mode to the receiver mode to search for the wireless power transmission apparatus.

The wirelessly charged battery may further include a power terminal for supplying power charged in the load to the electronic device, wherein, when an intensity of the power supplied to the electronic device in the transmitter mode is greater than or equal to a predetermined reference value, the controller may switch the operation mode to the receiver mode.

The wirelessly charged battery may further include a communication unit configured to collect information about a battery charging level of an adjacent wirelessly charged battery connected in parallel or in series with the wirelessly charged battery, wherein, when the battery charging level of the wirelessly charged battery exceeds the battery charging level of the adjacent wirelessly charged battery, the controller may switch the operation mode to the transmitter mode, and controls the adjacent wirelessly charged battery to be charged using power charged in the battery.

The sensing unit may include a means to measure a temperature of a resistance element connected to a positive terminal of the load, wherein the controller may calculate the battery charging level based on the measured temperature.

In another embodiment, a wirelessly charged battery may include a battery including a core having magnetism, a coil surrounding an outer periphery of the core, and a load for charging electric power induced by the coil, and a detachable master detachably attached to one side of an outer periphery of the battery and configured to calculate a battery charging level based on an output voltage intensity of the battery and determine an operation mode according to the battery charging level to perform a control operation such that power is wirelessly transmitted or received.

In another embodiment, a computer-readable recording medium having recorded thereon a program for executing one of the methods may be provided.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

The method and apparatus according to the embodiments have the following effects.

Embodiments provide a wirelessly charged battery capable of being charged by wirelessly receiving power.

In addition, embodiments provide a battery type wireless power reception apparatus capable of being automatically charged wirelessly without using a separate charging device and a portable auxiliary battery, thereby minimizing user inconvenience.

In addition, embodiments provide a wireless charging control method capable of adaptively controlling an operation mode according to a battery charging level and a wirelessly charged battery therefor.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a system configuration diagram illustrating a wireless power transmission method using an electromagnetic resonance scheme according to an embodiment of the present disclosure.

FIG. 2 is a diagram illustrating a type and characteristics of a wireless power transmitter in an electromagnetic resonance scheme according to an embodiment of the present disclosure.

FIG. 3 is a diagram illustrating a type and characteristics of a wireless power receiver in an electromagnetic resonance scheme according to an embodiment of the present disclosure.

FIG. 4 shows equivalent circuit diagrams of a wireless power transmission system in an electromagnetic resonance scheme according to an embodiment of the present disclosure.

FIG. 5 is a state transition diagram illustrating a state transition procedure of a wireless power transmitter in an electromagnetic resonance scheme according to an embodiment of the present disclosure;

FIG. 6 is a state transition diagram illustrating a state transition procedure of a wireless power receiver in an electromagnetic resonance scheme according to an embodiment of the present disclosure;

FIG. 7 illustrates operation regions of a wireless power receiver according to VRECT in an electromagnetic resonance scheme according to an embodiment of the present disclosure;

FIG. 8 is a block diagram illustrating configuration of a wirelessly charged battery according to an embodiment of the present disclosure;

FIG. 9 is a perspective view illustrating an internal structure of a wirelessly charged battery according to an embodiment of the present disclosure;

FIG. 10 is a view illustrating a structure of a wirelessly charged battery capable of transmitting and receiving wireless power according to another embodiment of the present disclosure;

FIG. 11 is a view illustrating an electronic-device-mounted wirelessly charged battery operating in a master-slave structure and a method for operating the same according to an embodiment of the present disclosure;

FIG. 12 is a view illustrating an electronic-device-mounted wirelessly charged battery operating in a master-slave structure and a method of operating the same according to another embodiment of the present disclosure;

FIG. 13 is a view illustrating an electronic-device-mounted wirelessly charged battery operating in a master-slave structure and a method of operating the same according to another embodiment of the present disclosure;

FIGS. 14 and 15 are views illustrating an electronic-device-mounted configuration of a wirelessly charged battery including only masters according to an embodiment of the present disclosure;

FIG. 16 is a flowchart illustrating a method for receiving wireless power in a wirelessly charged battery according to an embodiment of the present disclosure; and

FIG. 17 is a flowchart illustrating a method for transmitting and receiving wireless power in a wirelessly charged battery according to another embodiment of the present disclosure.

### BEST MODE

A wireless charging control method in a wirelessly charged battery mountable on an electronic device according to an embodiment of the present disclosure may include calculating a battery charging level of the wirelessly charged battery, switching an operation mode of the wirelessly charged battery to a receiver mode when the battery charging level is lower than a predetermined receiver mode threshold, and when the operation mode is switched to the receiver mode, searching for a wireless power transmission apparatus, receiving a power signal from the searched wireless power transmission apparatus and charging the battery.

### MODE FOR INVENTION

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

While all elements constituting embodiments of the present disclosure have been described as being connected into one body or operating in connection with each other, the disclosure is not limited to the described embodiments. That is, within the scope of the present disclosure, one or more of the elements may be selectively connected to operate. In addition, although all elements can be implemented as one independent hardware device, some or all of the elements may be selectively combined to implement a computer program having a program module for executing a part or all of the functions combined in one or more hardware devices. Code and code segments that constitute the computer program can be easily inferred by those skilled in the art. The computer program may be stored in a computer-readable storage medium, read and executed by a computer to implement an embodiment of the present disclosure. The storage medium of the computer program may include a magnetic recording medium, an optical recording medium, and a carrier wave medium.

In the description of the embodiments, it is to be understood that when an element is described as being “on” or “under” and “before” or “after” another element, it can be “directly” “on” or “under” and “before” or “after” another element or can be “indirectly” formed such that one or more other intervening elements are also present between the two elements.

The terms “include,” “comprise” and “have” should be understood as not precluding the possibility of existence or addition of one or more other components unless otherwise stated. All terms, including technical and scientific terms, have the same meaning as commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

In describing the components of the present disclosure, terms such as first, second, A, B, (a), and (b) may be used. These terms are used only for the purpose of distinguishing one constituent from another, and the terms do not limit the nature, order or sequence of the components. When one component is said to be “connected,” “coupled” or “linked” to another, it should be understood that this means the one component may be directly connected or linked to another one or another component may be interposed between the components.

In the description of the embodiments, “wireless power transmitter,” “wireless power transmission device,” “transmission terminal,” “transmitter,” “transmission device,” “transmission side,” and the like will be interchangeably used to refer to a device for transmitting wireless power in a wireless power system, for simplicity.

In addition, “wireless power reception device,” “wireless power receiver,” “reception terminal,” “reception side,” “reception device,” “receiver,” and the like will be interchangeably used to refer to a device for receiving wireless power from a wireless power transmission device, for simplicity.

The wireless power transmitter according to the present disclosure may be configured as a pad type, a cradle type, an access point (AP) type, a small base station type, a stand type, a ceiling embedded type, a wall-mounted type, a vehicle embedded type, a vehicle resting type, or the like. One transmitter may transmit power to a plurality of wireless power reception devices at the same time.

To this end, the wireless power transmitter may provide at least one wireless power transmission scheme, including, for example, an electromagnetic induction scheme, an electromagnetic resonance scheme, and the like.

For example, for the wireless power transmission schemes, various wireless power transmission standards based on an electromagnetic induction scheme for charging using an electromagnetic induction principle in which a magnetic field is generated in a power transmission terminal coil and electricity is induced in a reception terminal coil by the influence of the magnetic field may be used. Here, the electromagnetic induction type wireless power transmission standards may include an electromagnetic induction type wireless charging technique defined in a Wireless Power Consortium (WPC) technique or a Power Matters Alliance (PMA) technique.

In another example, a wireless power transmission scheme may employ an electromagnetic resonance scheme in which a magnetic field generated by a transmission coil of a wireless power transmitter is tuned to a specific resonant frequency and power is transmitted to a wireless power receiver located at a short distance therefrom. For example, the electromagnetic resonance scheme may include a resonance type wireless charging technique defined in Alliance for Wireless Power (A4WP), which is a wireless charging technology standard organization.

In another example, a wireless power transmission scheme may employ an RF wireless power transmission scheme in which low power energy is transmitted to a wireless power receiver located at a remote location over an RF signal.

In another example of the present disclosure, the wireless power transmitter according to the present disclosure may be designed to support at least two wireless power transmission schemes among the electromagnetic induction scheme, the electromagnetic resonance scheme, and the RF wireless power transmission scheme.

In this case, the wireless power transmitter may determine not only a wireless power transmission scheme that the wireless power transmitter and the wireless power receiver are capable of supporting, but also a wireless power transmission scheme which may be adaptively used for the wireless power receiver based on the type, state, required power, etc. of the wireless power receiver.

A wireless power receiver according to an embodiment of the present disclosure may be provided with at least one wireless power transmission scheme, and may simultaneously receive wireless power from two or more wireless power transmitters. Here, the wireless power transmission scheme may include at least one of the electromagnetic induction scheme, the electromagnetic resonance scheme, and the RF wireless power transmission scheme.

The wireless power receiver according to the present disclosure may be embedded in small electronic devices such as a mobile phone, a smartphone, a laptop computer, a digital broadcast terminal, a PDA (Personal Digital Assistant), a PMP (Portable Multimedia Player), a navigation system, an MP3 player, an electric toothbrush, an electronic tag, a lighting device, a remote control, a fishing float, and the like. However, embodiments are not limited thereto, and the wireless power receiver may be applied to any devices which may be provided with the wireless power receiving means according to the present disclosure and be charged through a battery. A wireless power receiver according to another embodiment of the present disclosure may be mounted on a vehicle, an unmanned aerial vehicle, a drone, and the like.

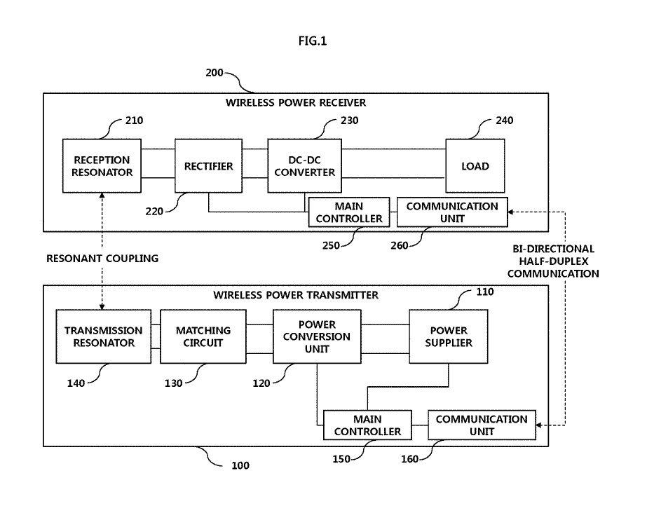

FIG. 1 is a system configuration diagram illustrating a wireless power transmission method using an electromagnetic resonance scheme according to an embodiment of the present disclosure.

Referring to FIG. 1, a wireless power transmission system may include a wireless power transmitter 100 and a wireless power receiver 200.

While FIG. 1 illustrates that the wireless power transmitter 100 transmits wireless power to one wireless power receiver 200, this is merely one embodiment, and the wireless power transmitter 100 according to another embodiment of the present disclosure may transmit wireless power to a plurality of wireless power receivers 200. It should be noted that the wireless power receiver 200 according to yet another embodiment may simultaneously receive wireless power from a plurality of wireless power transmitters 100.

The wireless power transmitter 100 may generate a magnetic field using a specific power transmission frequency (for example, a resonant frequency) to transmit power to the wireless power receiver 200.

The wireless power receiver 200 may receive power by tuning to the same frequency as the power transmission frequency used by the wireless power transmitter 100.

As an example, the frequency used for power transmission may be, but is not limited to, a 6.78 MHz band.

That is, the power transmitted by the wireless power transmitter 100 may be communicated to the wireless power receiver 200 that is in resonance with the wireless power transmitter 100.

The maximum number of wireless power receivers 200 capable of receiving power from one wireless power transmitter 100 may be determined based on the maximum transmit power level of the wireless power transmitter 100, the maximum power reception level of the wireless power receiver 200, and the physical structures of the wireless power transmitter 100 and the wireless power receiver 200.

The wireless power transmitter 100 and the wireless power receiver 200 can perform bidirectional communication in a frequency band different from the frequency band for wireless power transmission, i.e., the resonant frequency band. As an example, bidirectional communication may employ, without being limited to, a half-duplex Bluetooth low energy (BLE) communication protocol.

The wireless power transmitter 100 and the wireless power receiver 200 may exchange the characteristics and state information on each other including, for example, power negotiation information for power control via bidirectional communication.

As an example, the wireless power receiver 200 may transmit predetermined power reception state information for controlling the level of power received from the wireless power transmitter 100 to the wireless power transmitter 100 via bidirectional communication. The wireless power transmitter 100 may dynamically control the transmit power level based on the received power reception state information. Thereby, the wireless power transmitter 100 may not only optimize the power transmission efficiency, but also provide a function of preventing load breakage due to overvoltage, a function of preventing power from being wasted due to under-voltage, and the like.

The wireless power transmitter 100 may also perform functions such as authenticating and identifying the wireless power receiver 200 through bidirectional communication, identifying incompatible devices or non-rechargeable objects, identifying a valid load, and the like.

Hereinafter, a wireless power transmission process according to the resonance scheme will be described in more detail with reference to FIG. 1.

The wireless power transmitter 100 may include a power supplier 110, a power conversion unit 120, a matching circuit 130, a transmission resonator 140, a main controller 150, and a communication unit 160. The communication unit may include a data transmitter and a data receiver.

The power supplier 110 may supply a specific supply voltage to the power conversion unit 120 under control of the main controller 150. The supply voltage may be a DC voltage or an AC voltage.

The power conversion unit 120 may convert the voltage received from the power supplier 110 into a specific voltage under control of the main controller 150. To this end, the power conversion unit 120 may include at least one of a DC/DC converter, an AC/DC converter, and a power amplifier.

The matching circuit 130 is a circuit that matches impedances between the power conversion unit 120 and the transmission resonator 140 to maximize power transmission efficiency.

The transmission resonator 140 may wirelessly transmit power using a specific resonant frequency according to the voltage applied from the matching circuit 130.

The wireless power receiver 200 may include a reception resonator 210, a rectifier 220, a DC-DC converter 230, a load 240, a main controller 250 and a communication unit 260. The communication unit may include a data transmitter and a data receiver.

The reception resonator 210 may receive power transmitted by the transmission resonator 140 through the resonance effect.

The rectifier 220 may function to convert the AC voltage applied from the reception resonator 210 into a DC voltage.

The DC-DC converter 230 may convert the rectified DC voltage into a specific DC voltage required by the load 240.

The main controller 250 may control the operation of the rectifier 220 and the DC-DC converter 230 or may generate the characteristics and state information on the wireless power receiver 200 and control the communication unit 260 to transmit the characteristics and state information on the wireless power receiver 200 to the wireless power transmitter 100. For example, the main controller 250 may monitor the intensities of the output voltage and current from the rectifier 220 and the DC-DC converter 230 to control the operation of the rectifier 220 and the DC-DC converter 230.

The intensity information on the monitored output voltage and current may be transmitted to the wireless power transmitter 100 through the communication unit 260.

In addition, the main controller 250 may compare the rectified DC voltage with a predetermined reference voltage and determine whether the voltage is in an overvoltage state or an under-voltage state. When a system error state is sensed as a result of the determination, the controller 250 may transmit the sensed result to the wireless power transmitter 100 through the communication unit 260.

When the system error state is sensed, the main controller 250 may control the operation of the rectifier 220 and the DC-DC converter 230 or control the power applied to the load 240 using a predetermined overcurrent interruption circuit including a switch and/or a Zener diode, in order to prevent the load from being damaged.

In FIG. 1, the main controller 150 or 250 and the communication unit 160 or 260 of each of the transmitter and the receiver are shown as being configured as different modules, but this is merely one embodiment. It is to be noted that the main controller 150 or 250 and the communication unit 160 or 260 may be configured as a single module.

When an event such as addition of a new wireless power receiver to a charging area during charging, disconnection of a wireless power receiver that is being charged, completion of charging of the wireless power receiver, or the like is sensed, the wireless power transmitter 100 according to an embodiment of the present disclosure may perform a power redistribution procedure for the remaining wireless power receivers to be charged. The result of power redistribution may be transmitted to the connected wireless power receiver(s) via out-of-band communication.

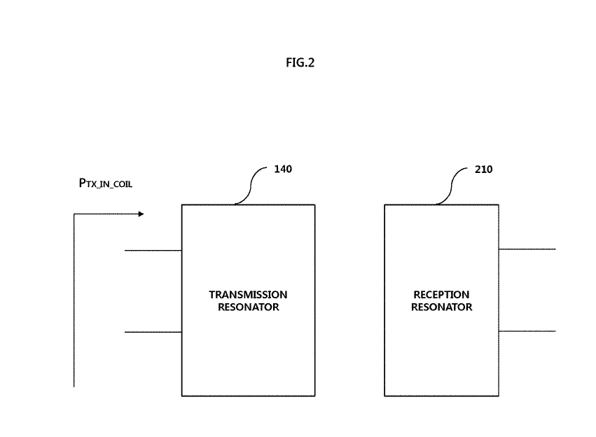

FIG. 2 is a diagram illustrating a type and characteristics of a wireless power transmitter in an electromagnetic resonance scheme according to an embodiment of the present disclosure.

Types and characteristics of the wireless power transmitter and the wireless power receiver according to the present disclosure may be classified into classes and categories.

The type and characteristics of the wireless power transmitter may be broadly identified by the following three parameters.

First, the wireless power transmitter may be identified by a class determined according to the intensity of the maximum power applied to the transmission resonator 140.

Here, the class of the wireless power transmitter may be determined by comparing the maximum value of the power P_{TX}_{_}_{IN}_{_}_{COIL} applied to the transmission resonator 140 with a predefined maximum input power for each class specified in a wireless power transmitter class table (hereinafter referred to as Table 1). Here, P_{TX}_{_}_{IN}_{_}_{COIL} may be an average real number value calculated by dividing the product of the voltage V(t) and the current I(t) applied to the transmission resonator 140 for a unit time by the unit time.

TABLE 1

| | | Minimum | |
|---|---|---|---|
| | | category | Maximum number |
| | Maximum input | support | of supportable |
| Class | power | requirements | devices |
| Class 1 | 2 W | 1 × Class 1 | 1 × Class 1 |
| Class 2 | 10 W | 1 × Class 3 | 2 × Class 2 |
| Class 3 | 16 W | 1 × Class 4 | 2 × Class 3 |
| Class 4 | 33 W | 1 × Class 5 | 3 × Class 3 |
| Class 5 | 50 W | 1 × Class 6 | 4 × Class 3 |
| Class 6 | 70 W | 1 × Class 6 | 5 × Class 3 |

The classes shown in Table 1 are merely an embodiment, and new classes may be added or existing classes may be deleted. It should also be noted that the maximum input power for each class, the minimum category support requirements, and the maximum number of supportable devices may vary depending on the use, shape, and implementation of the wireless power transmitter.

For example, referring to Table 1, when the maximum value of the power P_{TX}_{_}_{IN}_{_}_{COIL} applied to the transmission resonator 140 is greater than or equal to the value of P_{TX}_{_}_{IN}_{_}_{MAX} corresponding to Class 3 and less than the value of P_{TX}_{_}_{IN}_{_}_{MAX} corresponding to Class 4, the class of the wireless power transmitter may be determined as Class 3.

Second, the wireless power transmitter may be identified according to the minimum category support requirements corresponding to the identified class.

Here, the minimum category support requirement may be a supportable number of wireless power receivers corresponding to the highest level category of the wireless power receiver categories which may be supported by the wireless power transmitter of the corresponding class. That is, the minimum category support requirement may be the minimum number of maximum category devices which may be supported by the wireless power transmitter. In this case, the wireless power transmitter may support wireless power receivers of all categories lower than or equal to the maximum category according to the minimum category requirement.

However, if the wireless power transmitter is capable of supporting a wireless power receiver of a category higher than the category specified in the minimum category support requirement, the wireless power transmitter may not be restricted from supporting the wireless power receiver.

For example, referring to Table 1, a wireless power transmitter of Class 3 should support at least one wireless power receiver of Category 5. Of course, in this case, the wireless power transmitter may support a wireless power receiver 100 that falls into a category lower than the category level corresponding to the minimum category support requirement.

It should also be noted that the wireless power transmitter may support a wireless power receiver of a higher level category if it is determined that the category whose level is higher than the category corresponding to the minimum category support requirement can be supported.

Third, the wireless power transmitter may be identified by the maximum number of supportable devices corresponding to the identified class. Here, the maximum number of supportable devices may be identified by the maximum number of supportable wireless power receivers corresponding to the lowest level category among the categories which are supportable in the class—hereinafter, simply referred to as the maximum number of supportable devices.

For example, referring to Table 1, the wireless power transmitter of Class 3 should support up to two wireless power receivers corresponding to Category 3 which is the lowest level category.

However, when the wireless power transmitter is capable of supporting more than the maximum number of devices corresponding to its own class, it is not restricted from supporting more than the maximum number of devices.

The wireless power transmitter according to the present disclosure must perform wireless power transmission within the available power for up to at least the number defined in Table 1 if there is no particular reason not to allow the power transmission request from the wireless power receivers.

In one example, if there is not enough available power to accept the power transmission request the wireless power transmitter may not accept a power transmission request from the wireless power receiver. Alternatively, it may control power adjustment of the wireless power receiver.

In another example, when the wireless power transmitter accepts a power transmission request, it may not accept a power transmission request from a corresponding wireless power receiver if the number of acceptable wireless power receivers is exceeded.

In another example, the wireless power transmitter may not accept a power transmission request from a wireless power receiver if the category of the wireless power receiver requesting power transmission exceeds a category level that is supportable in the class of the wireless power transmitter.

In another example, the wireless power transmitter may not accept a power transmission request of the wireless power receiver if the internal temperature thereof exceeds a reference value.

In particular, the wireless power transmitter according to the present disclosure may perform the power redistribution procedure based on the currently available power. The power redistribution procedure may be performed further considering at least one of a category, a wireless power reception state, a required power, a priority, and a consumed power of a wireless power receiver for power transmission, which will be described later.

Information on the at least one of the category, wireless power reception state, required power, priority, and consumed power of the wireless power receiver may be transmitted from the wireless power receiver to the wireless power transmitter through at least one control signal over an out-of-band communication channel.

Once the power redistribution procedure is completed, the wireless power transmitter may transmit the power redistribution result to the corresponding wireless power receiver via out-of-band communication.

The wireless power receiver may recalculate the estimated time required to complete charging based on the received power redistribution result and transmit the re-calculation result to the microprocessor of a connected electronic device. Subsequently, the microprocessor may control the display provided to the electronic device to display the recalculated estimated charging completion time. At this time, the displayed estimated charging completion time may be controlled so as to disappear after being displayed for a predetermined time.

According to another embodiment of the present disclosure, when the estimated time required to complete charging is recalculated, the microprocessor may control the recalculated estimated charging completion to be displayed together with information on the reason for re-calculation. To this end, the wireless power transmitter may also transmit the information on the reason for occurrence of power redistribution to the wireless power receiver when transmitting the power redistribution result.

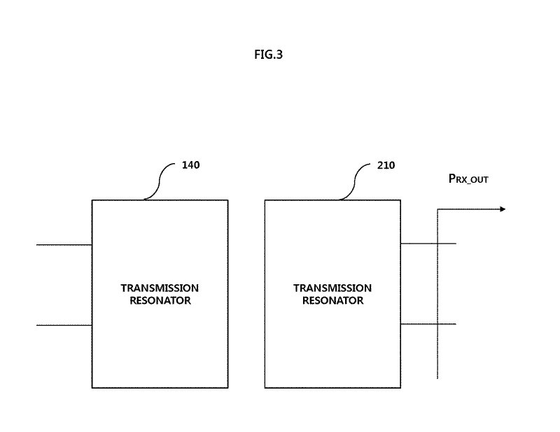

FIG. 3 is a diagram illustrating a type and characteristics of a wireless power receiver in an electromagnetic resonance scheme according to an embodiment of the present disclosure.

As shown in FIG. 3, the average output power P_{RX}_{_}_{OUT} of the reception resonator 210 is a real number value calculated by dividing the product of the voltage V(t) and the current I(t) output by the reception resonator 210 for a unit time by the unit time.

The category of the wireless power receiver may be defined based on the maximum output power P_{RX}_{_}_{OUT}_{_}_{MAX} of the reception resonator 210, as shown in Table 2 below.

TABLE 2

| | Maximum input | Application |
|---|---|---|
| Category | power | example |
| Category 1 | TBD | Bluetooth |
| | | handset |
| Category 2 | 3.5 W | Feature phone |
| Category 3 | 6.5 W | Smartphone |
| Category 4 | 13 W | Tablet |
| Category 5 | 25 W | Small laptop |
| Category 6 | 37.5 W | Laptop |
| Category 6 | 50 W | TBD |

For example, if the charging efficiency at the load stage is 80% or more, the wireless power receiver of Category 3 may supply power of 5 W to the charging port of the load.

The categories disclosed in Table 2 are merely an embodiment, and new categories may be added or existing categories may be deleted. It should also be noted that the maximum output power for each category and application examples shown in Table 2 may vary depending on the use, shape and implementation of the wireless power receiver.

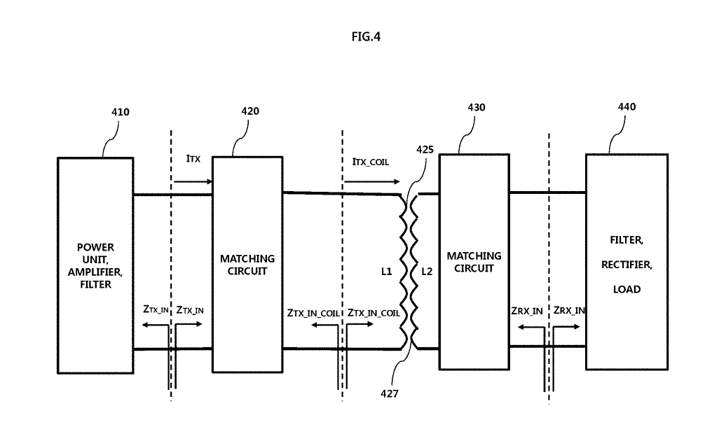

FIG. 4 shows equivalent circuit diagrams of a wireless power transmission system in an electromagnetic resonance scheme according to an embodiment of the present disclosure.

Specifically, FIG. 4 shows interface points on the equivalent circuit at which reference parameters, which will be described later, are measured.

Hereinafter, meanings of the reference parameters shown in FIG. 4 will be briefly described.

I_{TX} and I_{TX}_{_}_{COIL} denote the RMS (Root Mean Square) current applied to the matching circuit (or matching network) 420 of the wireless power transmitter and the RMS current applied to the transmission resonator coil 425 of the wireless power transmitter.

Z_{TX}_{_}_{IN} denotes the input impedance at the rear end of the power unit/amplifier/filter 410 of the wireless power transmitter and the input impedance at the front end of the matching circuit 420.

Z_{TX}_{_}_{IN}_{_}_{COIL} denotes the input impedance at the rear end of the matching circuit 420 and the front end of the transmission resonator coil 425.

L1 and L2 denote the inductance value of the transmission resonator coil 425 and the inductance value of the reception resonator coil 427, respectively.

Z_{RX}_{_}_{IN} denotes the input impedance at the rear end of the matching circuit 430 of the wireless power receiver and the front end of the filter/rectifier/load 440 of the wireless power receiver.

The resonant frequency used in the operation of the wireless power transmission system according to an embodiment of the present disclosure may be 6.78 MHz±15 kHz.

In addition, the wireless power transmission system according to an embodiment may provide simultaneous charging (i.e., multi-charging) for a plurality of wireless power receivers. In this case, even if a wireless power receiver is newly added or removed, the received power variation of the remaining wireless power receivers may be controlled so as not to exceed a predetermined reference value. For example, the received power variation may be ±10%, but embodiments are not limited thereto. If it is not possible to control the received power variation not to exceed the reference value, the wireless power transmitter may not accept the power transmission request from the newly added wireless power receiver.

The condition for maintaining the received power variation is that the existing wireless power receivers should not overlap a wireless power receiver that is added to or removed from the charging area.

When the matching circuit 430 of the wireless power receiver is connected to the rectifier, the real part of Z_{TX}_{_}_{IN} may be inversely proportional to the load resistance of the rectifier (hereinafter, referred to as R_{RECT}). That is, an increase in R_{RECT} may decrease Z_{TX}_{_}_{IN}, and a decrease in R_{RECT} may increase Z_{TX}_{_}_{IN}.

The resonator coupling efficiency according to the present disclosure may be a maximum power reception ratio calculated by dividing the power transmitted from the reception resonator coil to the load 440 by the power carried in the resonant frequency band in the transmission resonator coil 425. The resonator coupling efficiency between the wireless power transmitter and the wireless power receiver may be calculated when the reference port impedance Z_{TX}_{_}_{IN} of the transmission resonator and the reference port impedance Z_{RX}_{_}_{IN} of the reception resonator are perfectly matched.

Table 3 below is an example of the minimum resonator coupling efficiencies according to the classes of the wireless power transmitter and the classes of the wireless power receiver according to an embodiment of the present disclosure.

TABLE 3

| | Category 1 | Category 2 | Category 3 | Category 4 | Category 5 | Category 6 | Category 7 |
|---|---|---|---|---|---|---|---|
| Class 1 | N/A | N/A | N/A | N/A | N/A | N/A | N/A |
| Class 2 | N/A | 74% (−1.3) | 74% (−1.3) | N/A | N/A | N/A | N/A |
| Class 3 | N/A | 74% (−1.3) | 74% (−1.3) | 76% (−1.2) | N/A | N/A | N/A |
| Class 4 | N/A | 50% (−3) | 65% (−1.9) | 73% (−1.4) | 76% (−1.2) | N/A | N/A |
| Class 5 | N/A | 40% (−4) | 60% (−2.2) | 63% (−2) | 73% (−1.4) | 76% (−1.2) | N/A |
| Class 5 | N/A | 30% (−5.2) | 50% (−3) | 54% (−2.7) | 63% (−2) | 73% (−1.4) | 76% (−1.2) |

When a plurality of wireless power receivers is used, the minimum resonator coupling efficiencies corresponding to the classes and categories shown in Table 3 may increase.

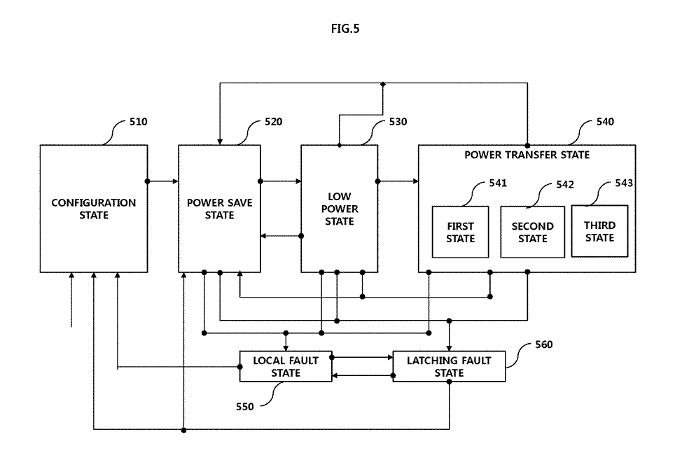

FIG. 5 is a state transition diagram illustrating a state transition procedure of a wireless power transmitter that supports the electromagnetic resonance scheme according to an embodiment of the present disclosure.

Referring to FIG. 5, the states of the wireless power transmitter may include a configuration state 510, a power save state 520, a low power state 530, a power transfer state 540, a local fault state 550, and a latching fault state 560.

When power is applied to the wireless power transmitter, the wireless power transmitter may transition to the configuration state 510. The wireless power transmitter may transition to a power save state 520 when a predetermined reset timer expires in the configuration state 510 or the initialization procedure is completed.

In the power save state 520, the wireless power transmitter may generate a beacon sequence and transmit the same through a resonant frequency band.

Here, the wireless power transmitter may control the beacon sequence to be initiated within a predetermined time after entering the power save state 520. For example, the wireless power transmitter may control the beacon sequence to be initiated within 50 ms after transition to the power save state 520. However, embodiments are not limited thereto.

In the power save state 520, the wireless power transmitter may periodically generate and transmit a first beacon sequence for sensing a wireless power receiver, and sense change in impedance of the reception resonator, that is, load variation. Hereinafter, for simplicity, the first beacon and the first beacon sequence will be referred to as a short beacon and a short beacon sequence, respectively.

In particular, the short beacon sequence may be repeatedly generated and transmitted at a constant time interval t_{CYCLE} during a short period t_{SHORT}_{_}_{BEACON} such that the standby power of the wireless power transmitter may be saved until a wireless power receiver is sensed. For example, t_{SHORT}_{_}_{BEACON} may be set to 30 ms or less, and t_{CYCLE} may be set to 250 ms±5 ms. In addition, the current intensity of the short beacon may be greater than a predetermined reference value, and may be gradually increased during a predetermined time period. For example, the minimum current intensity of the short beacon may be set to be sufficiently large such that a wireless power receiver of Category 2 or a higher category in Table 2 above may be sensed.

The wireless power transmitter according to the present disclosure may be provided with a predetermined sensing means for sensing change in reactance and resistance of the reception resonator according to the short beacon.

In addition, in the power save state 520, the wireless power transmitter may periodically generate and transmit a second beacon sequence for providing sufficient power necessary for booting and response of the wireless power receiver. Hereinafter, for simplicity, the second beacon and the second beacon sequence will be referred to as a long beacon and a long beacon sequence, respectively.

That is, the wireless power receiver may broadcast a predetermined response signal over an out-of-band communication channel when booting is completed through the second beacon sequence.

In particular, the long beacon sequence may be generated and transmitted at a constant time interval t_{LONG}_{_}_{BEACON}_{_}_{PERIOD} during a relatively long period t_{LONG}_{_}_{BEACON} compared to the short beacon to supply sufficient power necessary for booting the wireless power receiver. For example, t_{LONG}_{_}_{BEACON} may be set to 105 ms+5 ms, and t_{LONG}_{_}_{BEACON}_{_}_{PERIOD} may be set to 850 ms. The current intensity of the long beacon may be stronger than the current intensity of the short beacon. In addition, the long beacon may maintain the power of a certain intensity during the transmission period.

Thereafter, the wireless power transmitter may wait to receive a predetermined response signal during the long beacon transmission period after change in impedance of the reception resonator is sensed. Hereinafter, for simplicity, the response signal will be referred to as an advertisement signal. Here, the wireless power receiver may broadcast the advertisement signal in an out-of-band communication frequency band that is different from the resonant frequency band.

In one example, the advertisement signal may include at least one or any one of message identification information for identifying a message defined in the out-of-band communication standard, a unique service or wireless power receiver identification information for identifying whether the wireless power receiver is legitimate or compatible with the wireless power transmitter, information about the output power of the wireless power receiver, information about the rated voltage/current applied to the load, antenna gain information about the wireless power receiver, information for identifying the category of the wireless power receiver, wireless power receiver authentication information, information about whether or not the overvoltage protection function is provided, and version information about the software installed on the wireless power receiver.

Upon receiving the advertisement signal, the wireless power transmitter may establish an out-of-band communication link with the wireless power receiver after transitioning from the power save state 520 to the low power state 530. Subsequently, the wireless power transmitter may perform the registration procedure for the wireless power receiver over the established out-of-band communication link. For example, if the out-of-band communication is Bluetooth low-power communication, the wireless power transmitter may perform Bluetooth pairing with the wireless power receiver and exchange at least one of the state information, characteristic information, and control information about each other via the paired Bluetooth link.

If the wireless power transmitter transmits a predetermined control signal for initiating charging via out-of-band communication, i.e., a predetermined control signal for requesting that the wireless power receiver transmit power to the load, to the wireless power receiver in the low power state 530, the state of the wireless power transmitter may transition from the low power state 530 to the power transfer state 540.

If the out-of-band communication link establishment procedure or registration procedure is not normally completed in the low power state 530, the wireless power transmitter may transition from the low power state 530 to the power save state 520.

A separate independent link expiration timer by which the wireless power transmitter may connect to each wireless power receiver may be driven, and the wireless power receiver may transmit a predetermined message for announcing its presence to the wireless power transmitter in a predetermined time cycle before the link expiration timer expires. The link expiration timer is reset each time the message is received. If the link expiration timer does not expire, the out-of-band communication link established between the wireless power receiver and the wireless power receiver may be maintained.

If all of the link expiration timers corresponding to the out-of-band communication link established between the wireless power transmitter and the at least one wireless power receiver have expired in the low power state 530 or the power transfer state 540, the wireless power transmitter may transition to the power save state 520.

In addition, the wireless power transmitter in the low power state 530 may drive a predetermined registration timer when a valid advertisement signal is received from the wireless power receiver. When the registration timer expires, the wireless power transmitter in the low power state 530 may transition to the power save state 520. At this time, the wireless power transmitter may output a predetermined notification signal notifying that registration has failed through a notification display means (including, for example, an LED lamp, a display screen, and a beeper) provided in the wireless power transmitter.

Further, in the power transfer state 540, when charging of all connected wireless power receivers is completed, the wireless power transmitter may transition to the low power state 530.

In particular, the wireless power receiver may allow registration of a new wireless power receiver in states other than the configuration state 510, the local fault state 550, and the latching fault state 560.

In addition, the wireless power transmitter may dynamically control the transmit power based on the state information received from the wireless power receiver in the power transfer state 540.

Here, the receiver state information transmitted from the wireless power receiver to the wireless power transmitter may include at least one of required power information, information on the voltage and/or current measured at the rear end of the rectifier, charge state information, information indicating the overcurrent, overvoltage and/or overheated state, and information indicating whether or not a means for cutting off or reducing power transferred to the load according to the overcurrent or the overvoltage is activated. The receiver state information may be transmitted with a predetermined periodicity or transmitted every time a specific event is generated. In addition, the means for cutting off or reducing the power transferred to the load according to the overcurrent or overvoltage may be provided using at least one of an ON/OFF switch and a Zener diode.

According to another embodiment, the receiver state information transmitted from the wireless power receiver to the wireless power transmitter may further include at least one of information indicating that an external power source is connected to the wireless power receiver by wire and information indicating that the out-of-band communication scheme has changed (e.g., the communication scheme may change from NFC (Near Field Communication) to BLE (Bluetooth Low Energy) communication).

According to another embodiment of the present disclosure, a wireless power transmitter may adaptively determine the intensity of power to be received by each wireless power receiver based on at least one of the currently available power of the power transmitter, the priority of each wireless power receiver, and the number of connected wireless power receivers. Here, the power intensity of each wireless power receiver may be determined as a proportion of power to be received with respect to the maximum power that may be processed by the rectifier of the corresponding wireless power receiver.

Here, the priorities of the wireless power receivers may be determined according to the intensity of power required by the receiver, the type of the receiver, current use of the receiver, the current charge, the current consumed power, and the like, but embodiments are not limited thereto. For example, the priority of each type of receiver may be determined in order of cellular phone, tablet, Bluetooth headset, and electric toothbrush, but embodiments are not limited thereto. In another example, when a receiver is currently in use, it may be assigned a higher priority than receivers which are not in use. As another example, the higher the power required by the receiver, the higher the assigned priority may be. In another example, the priority may be determined based on the current charge amount of the load mounted on the receiver, that is, the remaining charge amount. In another example, the priorities may be determined based on the power currently being consumed. It should also be noted that priorities may be determined by a combination of at least one of the above-described prioritization factors.

Thereafter, the wireless power transmitter may transmit, to the wireless power receiver, a predetermined power control command including information about the determined power intensity. Then, the wireless power receiver may determine whether power control can be performed based on the power intensity determined by the wireless power transmitter, and transmit the determination result to the wireless power transmitter through a predetermined power control response message.

According to another embodiment of the present disclosure, a wireless power receiver may transmit predetermined receiver state information indicating whether wireless power control can be performed according to a power control command of a wireless power transmitter before receiving the power control command.

The power transfer state 540 may be any one of a first state 541, a second state 542 and a third state 543 depending on the power reception state of the connected wireless power receiver.

In one example, the first state 541 may indicate that the power reception state of all wireless power receivers connected to the wireless power transmitter is a normal voltage state.

The second state 542 may indicate that the power reception state of at least one wireless power receiver connected to the wireless power transmitter is a low voltage state and there is no wireless power receiver which is in a high voltage state.

The third state 543 may indicate that the power reception state of at least one wireless power receiver connected to the wireless power transmitter is a high voltage state.

When a system error is sensed in the power save state 520, the low power state 530, or the power transfer state 540, the wireless power transmitter may transition to the latching fault state 560.

The wireless power transmitter in the latching fault state 560 may transition to either the configuration state 510 or the power save state 520 when it is determined that all connected wireless power receivers have been removed from the charging area.

In addition, when a local fault is sensed in the latching fault state 560, the wireless power transmitter may transition to the local fault state 550. Here, the wireless power transmitter in the local fault state 550 may transition back to the latching fault state 560 when the local fault is released.

On the other hand, in the case where the wireless power transmitter transitions from any one state among the configuration state 510, the power save state 520, the low power state 530, and the power transfer state 540 to the local fault state 550, the wireless power transmitter may transition to the configuration state 510 once the local fault is released.

The wireless power transmitter may interrupt the power supplied to the wireless power transmitter once it transitions to the local fault state 550. For example, the wireless power transmitter may transition to the local fault state 550 when a fault such as overvoltage, overcurrent, or overheating is sensed. However, embodiments are not limited thereto.

In one example, the wireless power transmitter may transmit, to at least one connected wireless power receiver, a predetermined power control command for reducing the intensity of power received by the wireless power receiver when overcurrent, overvoltage, or overheating is sensed.

In another example, the wireless power transmitter may transmit, to at least one connected wireless power receiver, a predetermined control command for stopping charging of the wireless power receiver when overcurrent, overvoltage, or overheating is sensed.

Through the above-described power control procedure, the wireless power transmitter may prevent damage to the device due to overvoltage, overcurrent, overheating, or the like.

If the intensity of the output current of the transmission resonator is greater than or equal to a reference value, the wireless power transmitter may transition to the latching fault state 560. The wireless power transmitter that has transitioned to the latching fault state 560 may attempt to make the intensity of the output current of the transmission resonator less than or equal to a reference value for a predetermined time. Here, the attempt may be repeated a predetermined number of times. If the latching fault state 560 is not released despite repeated execution, the wireless power transmitter may send, to the user, a predetermined notification signal indicating that the latching fault state 560 is not released, using a predetermined notification means. In this case, when all of the wireless power receivers positioned in the charging area of the wireless power transmitter are removed from the charging area by the user, the latching fault state 560 may be released.

On the other hand, if the intensity of the output current of the transmission resonator falls below the reference value within a predetermined time, or if the intensity of the output current of the transmission resonator falls below the reference value during the predetermined repetition, the latching fault state 560 may be automatically released. In this case, the wireless power transmitter may automatically transition from the latching fault state 560 to the power save state 520 to perform the sensing and identification procedure for a wireless power receiver again.

The wireless power transmitter in the power transfer state 540 may transmit continuous power and adaptively control the transmit power based on the state information on the wireless power receiver and predefined optimal voltage region setting parameters.

For example, the predefined optimal voltage region setting parameters may include at least one of a parameter for identifying a low voltage region, a parameter for identifying an optimum voltage region, a parameter for identifying a high voltage region, and a parameter for identifying an overvoltage region.

The wireless power transmitter may increase the transmit power if the power reception state of the wireless power receiver is in the low voltage region, and reduce the transmit power if the power reception state is in the high voltage region.

The wireless power transmitter may also control the transmit power to maximize power transmission efficiency.

The wireless power transmitter may also control the transmit power such that the deviation of the power required by the wireless power receiver is less than or equal to a reference value.

In addition, the wireless power transmitter may stop transmitting power when the output voltage of the rectifier of the wireless power receiver reaches a predetermined overvoltage region, namely, when overvoltage is sensed.

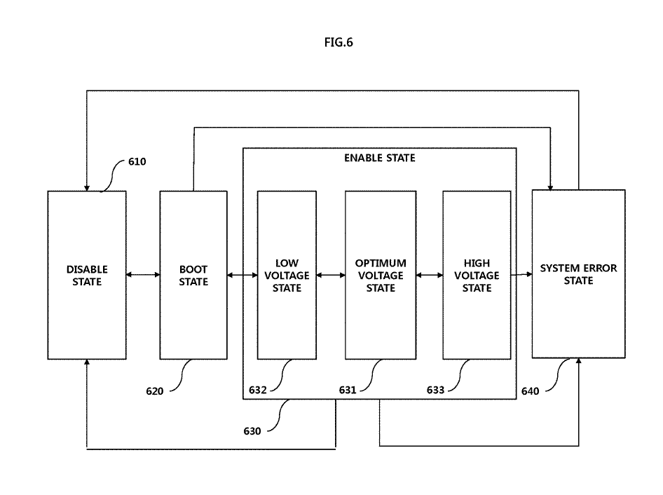

FIG. 6 is a state transition diagram illustrating a state transition procedure of a wireless power receiver in an electromagnetic resonance scheme according to an embodiment of the present disclosure.

Referring to FIG. 6, the states of the wireless power receiver may include a disable state 610, a boot state 620, an enable state (or on state) 630 and a system error state 640.

The state of the wireless power receiver may be determined based on the intensity of the output voltage at the rectifier end of the wireless power receiver (hereinafter referred to as V_{RECT} for simplicity).

The enable state 630 may be divided into an optimum voltage 631, a low voltage state 632 and a high voltage state 633 according to the value of V_{RECT}.

The wireless power receiver in the disable state 610 may transition to the boot state 620 if the measured value of V_{RECT} is greater than or equal to the predefined value of V_{RECT}_{_}_{BOOT}.

In the boot state 620, the wireless power receiver may establish an out-of-band communication link with a wireless power transmitter and wait until the value of V_{RECT} reaches the power required at the load stage.

When it is sensed that the value of V_{RECT} has reached the power required at the load stage, the wireless power receiver in the boot state 620 may transition to the enable state 630 and begin charging.

The wireless power receiver in the enable state 630 may transition to the boot state 620 when it is sensed that charging is completed or interrupted.

In addition, the wireless power receiver in the enable state 630 may transition to the system error state 640 when a predetermined system error is sensed. Here, the system error may include overvoltage, overcurrent, and overheating, as well as other predefined system error conditions.

In addition, the wireless power receiver in the enable state 630 may transition to the disable state 610 if the value of V_{RECT} falls below the value of V_{RECT}_{_}_{BOOT}.

In addition, the wireless power receiver in the boot state 620 or the system error state 640 may transition to the disable state 610 if the value of V_{RECT} falls below the value of V_{RECT}_{_}_{BOOT}.

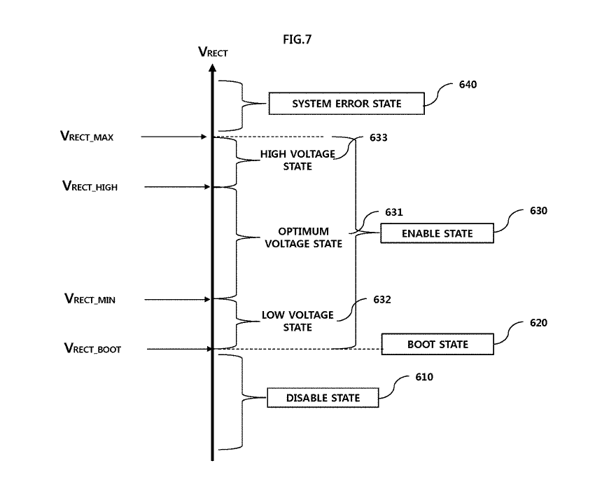

Hereinafter, state transition of the wireless power receiver in the enable state 630 will be described in detail with reference to FIG. 7.

FIG. 7 illustrates operation regions of a wireless power receiver according to V_{RECT} in an electromagnetic resonance scheme according to an embodiment of the present disclosure.

Referring to FIG. 7, if the value of V_{RECT} is less than a predetermined value of V_{RECT}_{_}_{BOOT}, the wireless power receiver is maintained in the disable state 610.

Thereafter, when the value of V_{RECT} is increased beyond V_{RECT}_{_}_{BOOT}, the wireless power receiver may transition to the boot state 620 and broadcast an advertisement signal within a predetermined time. Thereafter, when the advertisement signal is sensed by the wireless power transmitter, the wireless power transmitter may transmit a predetermined connection request signal for establishing an out-of-band communication link to the wireless power receiver.

Once the out-of-band communication link is normally established and successfully registered, the wireless power receiver may wait until the value of V_{RECT} reaches the minimum output voltage of the rectifier for normal charging (hereinafter referred to as V_{RECT}_{_}_{MIN} for simplicity).

If the value of V_{RECT} exceeds V_{RECT}_{_}_{MIN}, the wireless power receiver may transition from the boot state 620 to the enable state 630 and may begin charging the load.

If the value of V_{RECT} in the enable state 630 exceeds a predetermined reference value V_{RECT}_{_}_{MAX} for determining overvoltage, the wireless power receiver may transition from the enable state 630 to the system error state 640.

Referring to FIG. 7, the enable state 630 may be divided into the low voltage state 632, the optimum voltage 631 and the high voltage state 633 according to the value of V_{RECT}.

The low voltage state 632 may refer to a state in which V_{RECT}_{_}_{BOOT}≤V_{RECT}≤V_{RECT}_{_}_{MIN}, the optimum voltage state 631 may refer to a state in which V_{RECT}_{_}_{MIN}<V_{RECT}≤V_{RECT}_{_}_{HIGH}, and the high voltage state 633 may refer to a state in which V_{RECT}_{_}_{HIGH}<V_{RECT}≤V_{RECT}_{_}_{MAX}.

In particular, the wireless power receiver having transitioned to the high voltage state 633 may suspend the operation of cutting off the power supplied to the load for a predetermined time (hereinafter referred to as a high voltage state maintenance time for simplicity). The high voltage state maintenance time may be predetermined so as not to cause damage to the wireless power receiver and the load in the high voltage state 633.

When the wireless power receiver transitions to the system error state 640, it may transmit a predetermined message indicating occurrence of overvoltage to the wireless power transmitter through the out-of-band communication link within a predetermined time.

The wireless power receiver may also control the voltage applied to the load using an overvoltage interruption means provided to prevent damage to the load due to the overvoltage in the system fault state 630. Here, an ON/OFF switch and/or a Zener diode may be used as the overvoltage interruption means.

Although a method and means for coping with a system error in a wireless power receiver when overvoltage is generated and the wireless power receiver transitions to the system error state 640 have been described in the above embodiment, this is merely an embodiment. In other embodiments, the wireless power receiver may transition to the system error state due to overheating, overcurrent, and the like.

As an example, in the case where the wireless power receiver transitions to the system error state due to overheating, the wireless power receiver may transmit a predetermined message indicating the occurrence of overheating to the wireless power transmitter. In this case, the wireless power receiver may drive a cooling fan or the like to reduce the internally generated heat.

According to another embodiment of the present disclosure, a wireless power receiver may receive wireless power in conjunction with a plurality of wireless power transmitters. In this case, the wireless power receiver may transition to the system error state 640 if it is determined that the wireless power transmitter from which the wireless power receiver is determined to actually receive wireless power is different from the wireless power transmitter with which the out-of-band communication link is actually established.

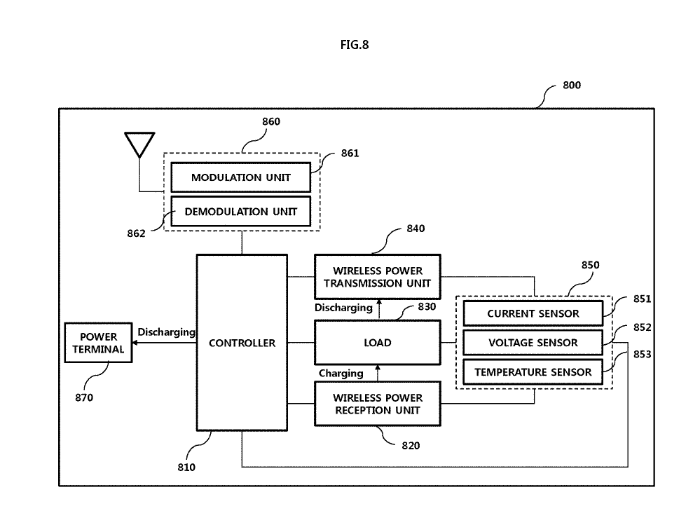

FIG. 8 is a block diagram illustrating configuration of a wirelessly charged battery according to an embodiment of the present disclosure.

Referring to FIG. 8, a wirelessly charged battery 800 may include a controller 810, a wireless power reception unit 820, a load 830, a wireless power transmission unit 840, a sensing unit 850, a communication unit 860, and a power terminal 870.

The wireless power reception unit 820 may function to receive a power signal transmitted by the wireless power transmission apparatus under control of the controller 810 to charge the load 830.

To this end, the wireless power reception unit 820 may include a reception coil for receiving an AC power signal, a rectifier for converting the AC signal into a DC signal, and a transformer for converting the rectified DC signal into a voltage required by the load 830. However, embodiments are not limited thereto.

In addition, when a beacon signal or a ping signal transmitted by the wireless power transmitter is sensed, the wireless power reception unit 820 may function to transmit the result of sensing to the controller 810.

The communication unit 860 may include a modulation unit 861 configured to modulate a control signal and state information received from the controller 810 and to transmit the modulated signal and information through an antenna provided thereto, and a demodulation unit 861 configured to demodulate the signal received through the provided antenna and to transmit the demodulated signal to the controller 810.

For example, the communication unit 860 may provide a communication function through a specific frequency band (hereinafter referred to as an out-of-band communication band) different from a frequency band for transmitting and receiving a power signal (hereinafter referred to as an in-band band). Here, the out-of-band communication may include Bluetooth communication and may be activated when power signal transmission/reception is performed in the electromagnetic resonance scheme.

The communication unit 860 may function to demodulate the power signal received through the wireless power reception unit 820 and transmit the demodulated power signal to the controller 810 and to modulate a control signal received from the controller 810 and transmit the modulated control signal to the wireless power transmission unit 840. That is, the communication unit 860 may perform the in-band communication function of transmitting and receiving control signals using the same frequency band as the frequency band used for power signal transmission.

The wireless power transmission unit 820 may be supplied with power from the charged load 830 under control of the controller 810 and transmit a power signal through a transmission coil.

In addition, the wireless power transmitter 820 may transmit a predetermined power signal for sensing and identifying the wireless power receiver or another wirelessly charged battery according to the control signal of the controller 810. For example, the power signal for sensing and identification may include, but is not limited to, an electromagnetic resonant beacon signal and an electromagnetic inducible ping signal. Here, the beacon signal may include a short beacon signal and a long beacon signal, and the ping signal may include an analog ping signal and a digital ping signal.

The controller 810 may control the overall operation of the wirelessly charged battery 800, and exchange various kinds of control signals and state information with the wireless power transmitter or the wireless power receiver through the communication unit 860 according to an operation mode of the wirelessly charged battery 800. Here, the operation mode may include a receiver mode and a transmitter mode, and the controller 810 may adaptively determine the operation mode according to a battery charging state. For example, when the battery charging level is lower than or equal to a predetermined first reference value, the controller 810 may control the wirelessly charged battery 800 to operate in the receiver mode to charge the load 830. When the battery charging level is higher than or equal to a predetermined second reference value, the controller 810 may switch to the transmitter mode and control the power charged in the load 830 to be supplied to another wirelessly charged battery or the wireless power receiver.

Accordingly, the wirelessly charged battery 800 according to an embodiment of the present disclosure may function as a power relay that receives power through an external power source (including a power outlet) through the adaptive operation mode change and delivers the power the charged load 830) to a wireless power receiver that is placed at a location where power is not receivable from the wireless power transmitter, wherein the wireless power receiver may include the wirelessly charged battery 800.

Generally, the distance over which the electric power can be transmitted wirelessly according to the electromagnetic resonance scheme is limited to a few meters, and the distance over which the electric power can be transmitted wirelessly according to the electromagnetic induction scheme is limited to a few centimeters. Accordingly, the wirelessly charged battery 800 according to the present disclosure may be utilized as a means for extending the power relay distance of the wireless power transmitter.

The controller 810 may collect information about the intensity of a battery output voltage measured by the sensing unit 850, and calculate the battery charging level B_level based on the intensity of the battery output voltage V_out. In general, as the battery charging level B_level is lowered, the intensity of the battery output voltage V_out may also be reduced.

If it is determined that the calculated battery charging level B_level is lower than a predetermined threshold B_threshold, the controller 810 may set the operation mode to the receiver mode and search for a wireless power transmission apparatus to receive the power.

According to an embodiment of the present disclosure, the wirelessly charged battery 800 may have a function of wireless power reception according to at least one of the electromagnetic resonance scheme and/or the electromagnetic induction scheme.

For example, the controller 810 may start searching for a wireless power transmission apparatus in the electromagnetic resonance scheme. When the search is successful, the controller 810 stats receiving power from the discovered wireless power transmission apparatus according to the electromagnetic resonance scheme, thereby charging the load 830. If the controller 810 fails to discover the wireless power transmission apparatus through the electromagnetic resonance scheme, the controller 810 may search for a wireless power transmission apparatus using the electromagnetic induction scheme. Thereafter, when a wireless power transmission apparatus supporting the electromagnetic induction scheme is discovered, reception of power from the discovered wireless power transmission apparatus in the electromagnetic induction scheme may be initiated to charge the load 830.

When the battery charging level (B_level) reaches a full charging level B_max, the controller 810 may terminate wireless power reception. When charging is completed, the controller 810 may transmit a predetermined control signal or state information to the wireless power transmission apparatus through the communication unit 860 to indicate that the charging is completed.

According to another embodiment of the present disclosure, the wirelessly charged battery 800 may switch from the receiver mode to the transmitter mode when the battery charging level B_level is higher than or equal to a predetermined threshold.

For example, when the battery charging level B_level in the receiver mode reaches a predetermined power transmission start level B_tx_start, the controller 810 may switch to the transmitter mode to start searching for a wireless power receiver. If search is successful, the controller 810 may control the wireless power transmission unit 840 to start wireless power transmission to the discovered wireless power receiver using the power charged in the load 830. In the transmitter mode, when the battery charging level B_level falls below a predetermined power transmission stop level B_tx_stop, the controller 810 may switch from the transmitter mode to the receiver mode to control the reception unit 820 to resume charging the load 830.

According to an embodiment, the power transmission start level B_tx_start may be the full charging level B_max, but embodiments are not limited thereto. The power transmission start level B_tx_start may be predetermined according to the battery charging capacity of the wirelessly charged battery 800.

According to another embodiment, the power transmission start level B_tx_start may be dynamically determined based on whether or not power is supplied to an electronic device through the power terminal 870 of the wirelessly charged battery 800 and the intensity of current/voltage supplied to the electronic device.

As another example, the controller 810 may block switching to the transmitter mode when the electronic device is in use, i.e., when power is supplied to the electronic device.

The sensing unit 850 may function to measure at least one of current, voltage, or temperature of the wireless power reception unit 820, the load 830, the wireless power transmission unit 840, and the power terminal 870 and transmit the same to the controller 810.

To this end, the sensing unit 850 may include at least one of a current sensor 851 for measuring the intensity of the current, a voltage sensor 852 for measuring the intensity of the voltage, or a temperature sensor 853 for measuring the temperature.

While it is illustrated in FIG. 8 that the charging level B_level of the load 830 may be calculated based on the intensity of the output voltage V_out of the load 830, this is merely one embodiment. According to another embodiment of the present disclosure, the charging level B_level of the load 830 may be calculated based on change in temperature of a resistance element according to current flowing through both ends (positive and negative terminals) of the load 830. For example, as the intensity of current and voltage applied to both ends of the load 830 increases, the temperature of the resistance element may increase. As the intensity of current and voltage applied to both ends of the load 830 decreases, the temperature of the resistance element may decrease.

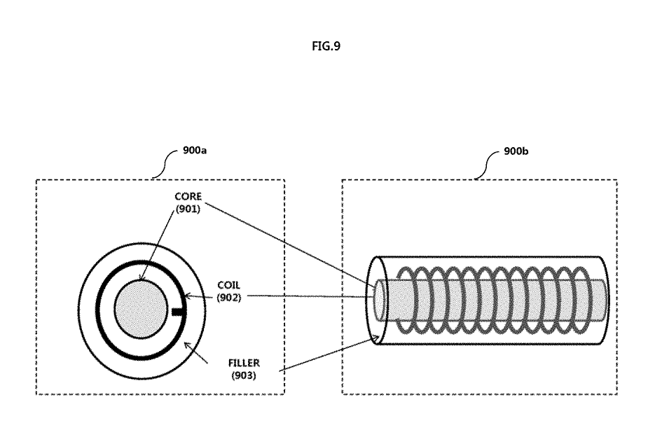

FIG. 9 is a perspective view illustrating an internal structure of a wirelessly charged battery according to an embodiment of the present disclosure.

Referring to FIG. 9, the cross-sectional surface 900a of the wirelessly charged battery 800 may include a core 901 and a coil 902, wherein the area thereof excluding the part occupied by the core 901 and the coil 902 may be filled with a filler 903 of a plastic material, for example, polycarbonate (PC).

In one example, the core 901 may be a plastic or ferrite rod having magnetism, but embodiments are not limited thereto. According to another embodiment, the core 901 may be made of a liquid having magnetism. Here, since the magnetic plastics may be formed by mixing magnets such as barium ferrite, strontium ferrite, rare earth cobalt and Alnico with plastics such as nylon or polyethylene since plastics do not have magnetism.

The coil 902 may be configured to surround the core 901, as indicated by reference numeral 900b.

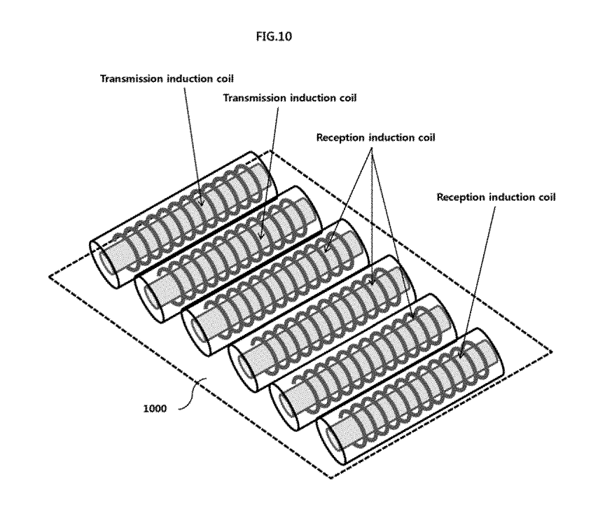

FIG. 10 is a view illustrating a structure of a packed wirelessly charged battery capable of transmitting and receiving wireless power according to another embodiment of the present disclosure.

Referring to FIG. 10, a packed wirelessly charged battery 1000 may be configured in the form of a pack by connecting a plurality of wirelessly charged batteries in parallel, and the coils of the respective wirelessly charged batteries may be used for different purposes. For example, as shown in FIG. 10, the coil of each wirelessly charged battery may be any one of a transmission induction coil, a transmission resonance coil, a reception resonance coil, and a reception induction coil.

According to an embodiment of the present disclosure, the controller 810 of the wirelessly charged battery 800 may dynamically activate the coils of the packed wirelessly charged battery 1000 according to the operation mode determined according to the battery charging level. For example, when the wirelessly charged battery 800 operates in the receiver mode, which uses the electromagnetic resonance scheme, the controller 800 may activate only the reception resonance coil. On the other hand, when the wirelessly charged battery 800 operates in the transmitter mode, which uses the electromagnetic resonance scheme, the controller 810 may activate only the transmission resonance coil.

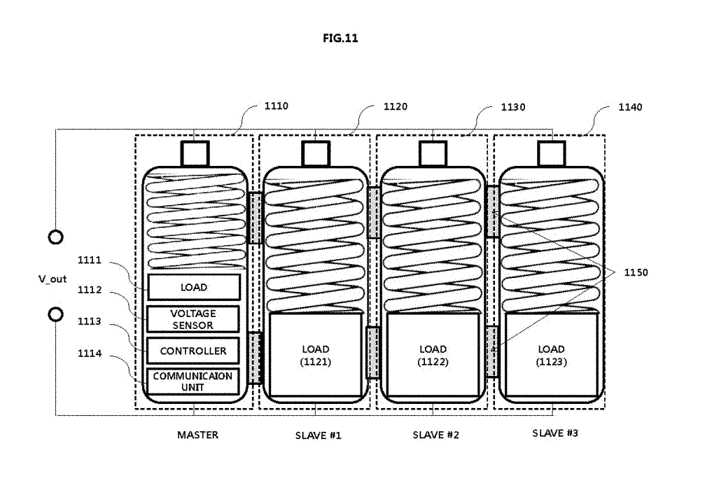

FIG. 11 is a view illustrating an electronic-device-mounted wirelessly charged battery operating in a master-slave relationship and a method for operating the same according to an embodiment of the present disclosure.

A wirelessly charged battery mounted on an electronic device may be configured by connecting one master wirelessly charged battery and at least one slave charging battery in parallel.

For example, as shown in FIG. 11, one master wirelessly charged battery 1110 and three slave wirelessly charged batteries 1120 to 1140 may be connected to each other in parallel using a predetermined type of connection means 1150.

The master wirelessly charged battery 1110 may include the core 901 and the coil 902 of FIG. 9 described above, and may further include a load 1111, a voltage sensor 1112, a controller 1113, and a communication unit 1114. It should be noted that, as another example, the master wirelessly charged battery 1110 may further include at least one of the elements illustrated in FIG. 8.

The voltage sensor 1112 may measure the output voltage intensity V_out of the parallel-connected wirelessly charged battery and provide the same to the controller 1113.

The controller 1113 may calculate the battery charging level B_level based on the output voltage intensity V_out and determine whether or not reception of power from a wireless power transmission apparatus is needed based on the calculated battery charging level B_Level.

As a result of the determination, if power reception is needed, the controller 1113 may detect the wireless power transmission apparatus and transmit a predetermined control signal requesting power transmission to the detected wireless power transmission apparatus through the communication unit 1114.

The master wirelessly charged battery 1110 and the three slave wirelessly charged batteries 1120 to 1140 may receive the power signal transmitted by the wireless power transmission apparatus and charge each of the loads 1111 and 1121 to 1123 provided therein.

When it is determined that battery charging is completed according to the output voltage intensity V_out, the controller 1113 may transmit a predetermined control signal indicating completion of battery charging to the wireless power transmission apparatus through the communication unit 114.

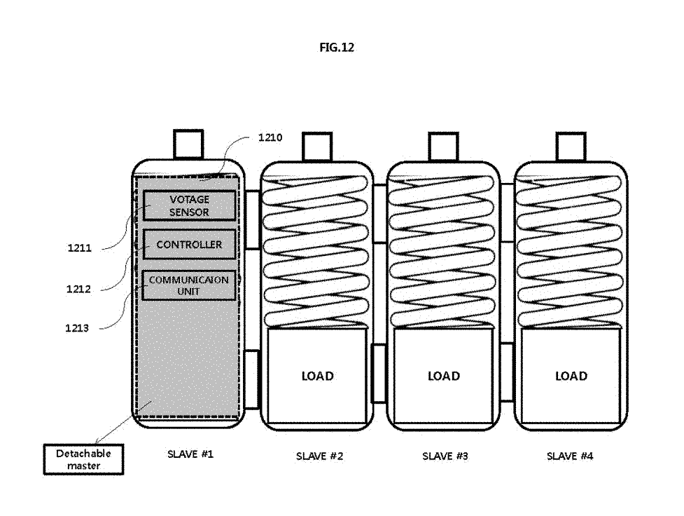

FIG. 12 is a view illustrating an electronic-device-mounted wirelessly charged battery operating in a master-slave relationship and a method of operating the same according to another embodiment of the present disclosure.

The wirelessly charged battery mounted on the electronic device may include a detachable master charging battery in place of the master wirelessly charged battery of FIG. 11 described above.

Here, as shown in FIG. 12, the detachable master charging battery 1210 may not include a separate load, and may be configured to be attached to and detached from one outer side of a slave charging battery having a load.

For example, as shown in FIG. 11, one detachable master charging battery 1210 may be mounted on any one of four slave charging batteries. The four slave charging batteries may be connected to each other in parallel using a predetermined type of connection means.

For the functions and operations of the voltage sensor 1211, the controller 1212 and the communication unit 1213 constituting the detachable master charging battery 1210, refer to the description of the voltage sensor 1112, the controller 1113, and the communication unit 1114.

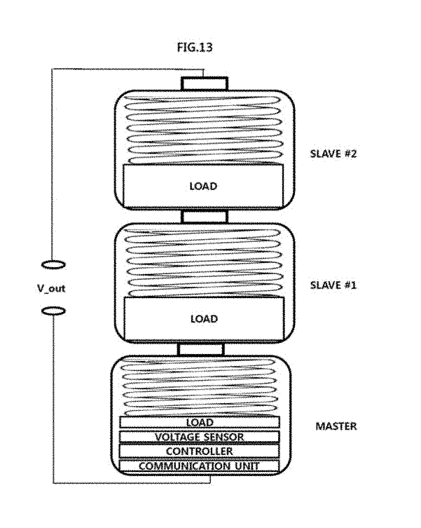

FIG. 13 is a view illustrating an electronic-device-mounted wirelessly charged battery operating in a master-slave relationship and a method of operating the same according to another embodiment of the present disclosure.

As shown in FIG. 13, a wirelessly charged battery mounted on an electronic device may be configured by connecting one master charging battery and at least one slave charging battery in series.

The voltage sensor of the master wirelessly charged battery may measure the output voltage intensity V_out of the serially connected wirelessly charged batteries, and the controller of the master wirelessly charged battery may calculate the battery charging level based on the output voltage intensity. In particular, when the battery charging level is lower than or equal to a predetermined threshold, the controller may search for a wireless power transmission apparatus to receive power from, and make a request to the discovered wireless power transmission apparatus for wireless power transmission, through the communication unit, to start charging the load.

While it is illustrated in FIG. 13 that the operation mode of the wirelessly charged battery is determined based on the battery charging level, this is merely an embodiment. It should be noted that, in another embodiment of the present disclosure, the operation mode may be determined based on the battery output voltage intensity. For example, the wirelessly charged battery may operate in the receiver mode if the battery output voltage intensity is below a predetermined threshold, and may operate in the transmitter mode when battery output voltage intensity reaches a maximum output voltage intensity.

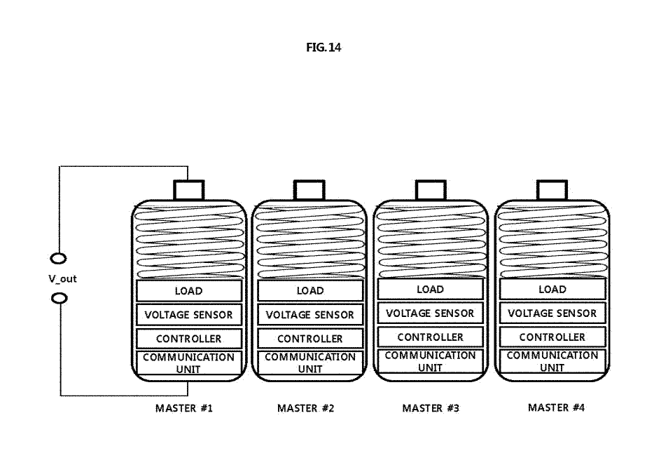

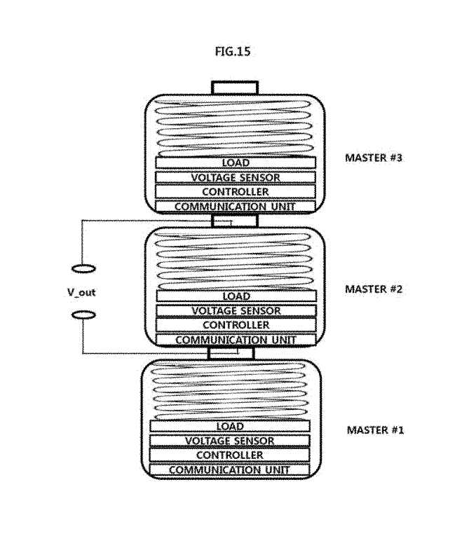

FIGS. 14 and 15 are views illustrating an electronic-device-mounted configuration of a wirelessly charged battery including only masters according to an embodiment of the present disclosure.

For example, as shown in FIG. 14, a plurality of master wirelessly charged batteries mounted on an electronic device may be arranged in parallel. Each of the master wirelessly charged batteries may independently perform a wireless charging operation. Thus, each master wirelessly charged battery may adaptively perform battery charging based on the battery charging level thereof.

As another example, as shown in FIG. 15, a plurality of master wirelessly charged batteries mounted on an electronic device may be arranged in series. Each of the master wirelessly charged batteries may independently perform a wireless charging operation. Thus, each master wirelessly charged battery may adaptively perform battery charging based on the battery charging level thereof.

In FIGS. 14 and 15, according to an embodiment, a master wirelessly charged battery may exchange various kinds of state information with adjacent master wirelessly charged batteries. Here, the state information may include battery charging level information.

If the battery charging level B_level of a first master wirelessly charged battery is lower than or equal to a predetermined first threshold and the battery charging level B_level of a second master wirelessly charged battery is higher than or equal to a second threshold value, which is greater than the first threshold, the second master wirelessly charged battery may operate in the transmitter mode and the first master wirelessly charged battery may operate in the receiver mode. That is, the second master wirelessly charged battery may transmit power to the first master wirelessly charged battery until the battery charging level B_level of the first master wirelessly charged battery reaches a certain level.

For example, if the charging capacity of the first master wirelessly charged battery is the same as that of the second master wirelessly charged battery, the current battery charging level of the first master wirelessly charged battery is 10% and the current battery charging level of the second master wirelessly charged battery is 90%, the second master wirelessly charged battery may transmit power to the first master wirelessly charged battery until the battery charging level of the first master wirelessly charged battery reaches 50%.

For example, wireless power transmission and reception may be performed between master wirelessly charged batteries connected in parallel and mounted on an electronic device, using the electromagnetic induction scheme, which has higher charging efficiency than the electromagnetic resonance scheme.

As another example, wireless power transmission and reception between a master wirelessly charged battery mounted on an electronic device and a wireless power transmission apparatus may be performed using the electromagnetic resonance scheme.

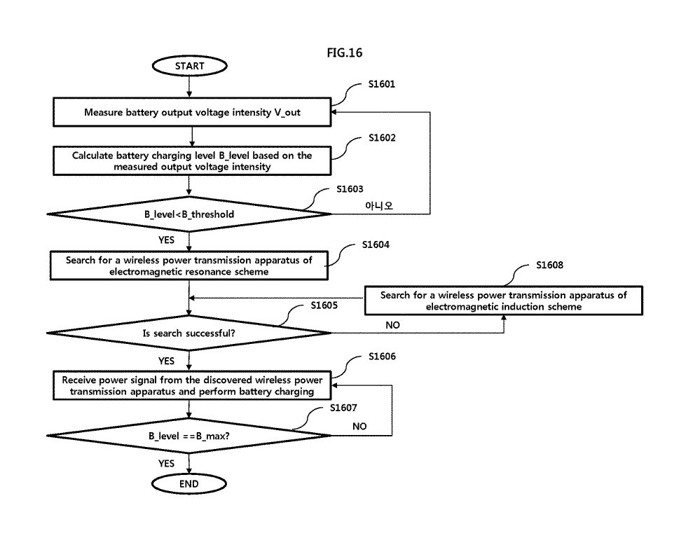

FIG. 16 is a flowchart illustrating a method for receiving wireless power in a wirelessly charged battery according to an embodiment of the present disclosure.

Referring to FIG. 16, a wirelessly charged battery may measure the battery output voltage intensity V_out and calculate the battery charging level B_level based on the measured output voltage intensity (S1601 and S1602).

If B_level is lower than a predefined battery charging threshold B_threshold, the wirelessly charged battery may search for a wireless power transmission apparatus of the electromagnetic resonance scheme (S1604).

If the wirelessly charged battery succeeds in searching for the wireless power transmission apparatus, the wirelessly charged battery may receive a power signal from the discovered wireless power transmission apparatus and perform battery charging (S1605 and S1606).

The wirelessly charged battery may compare B_level with a predetermined maximum battery charging level B_max to determine whether B_level has reached B_max (S1607).

If B_level coincides with B_max, the wirelessly charged battery may stop receiving power. Then, the wirelessly charged battery may transmit predetermined state information indicating that battery charging is completed to the wireless power transmission apparatus.

On the other hand, if B_level is lower than B_max in step 1607, the wirelessly charged battery may return to step 1606 and continue to charge the battery.

If the wirelessly charged battery fails to discover the wireless power transmission apparatus supporting the electromagnetic resonance scheme in step 1605, the wirelessly charged battery may search for a wireless power transmission apparatus of the electromagnetic induction scheme (S1608). If search for the wireless power transmission apparatus of the electromagnetic induction scheme is successful, the wirelessly charged battery may receive a power signal using the electromagnetic induction scheme to perform battery charging.

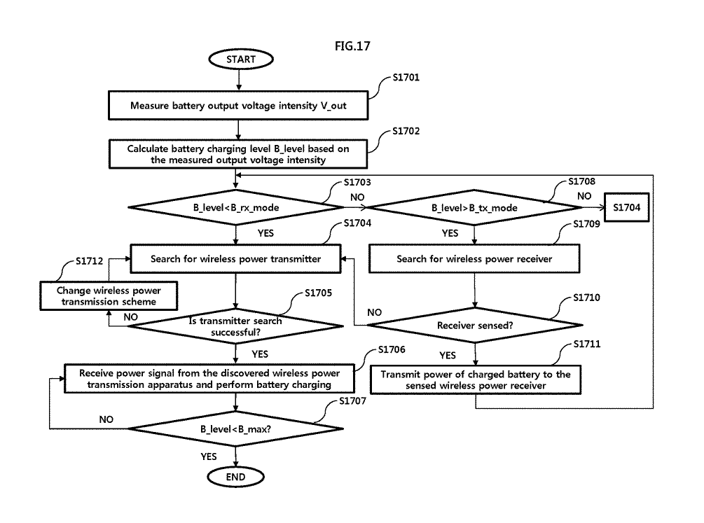

FIG. 17 is a flowchart illustrating a method for transmitting and receiving wireless power in a wirelessly charged battery according to another embodiment of the present disclosure.

Referring to FIG. 17, the wirelessly charged battery may measure the battery output voltage intensity V_out and calculate the battery charging level B_level based on the measured output voltage intensity (S1701 and S1702).

The wirelessly charged battery may compare B_level with a preset receiver mode threshold B_rx_mode to determine whether B_level is lower than B_rx_mode (S1703). Here, B_rx_mode may indicate a maximum battery charging level for maintaining the wirelessly charged battery in the receiver mode.

If B_level is lower than B_rx_mode as a result of comparison, the wirelessly charged battery may start searching for a wireless power transmitter (S1704).

If search for the wireless power transmission is successful, the wirelessly charged battery may receive a power signal from the discovered wireless power transmission apparatus and perform battery charging (S1705 and S1706).

The wirelessly charged battery may compare B_level with a predetermined maximum battery charging level B_max to determine whether B_level has reached B_max (S1707).

If B_level coincides with B_max, the wirelessly charged battery may stop receiving power. Then, the wirelessly charged battery may transmit predetermined state information indicating that battery charging is completed to the wireless power transmission apparatus.

On the other hand, if B_level is lower than B_max in step 1707, the wirelessly charged battery may return to step 1706 and continue to charge the battery.

In step 1705, if the wirelessly charged battery fails to locate the wireless power transmission apparatus, it may switch to a wireless power transmission scheme different from the wireless power transmission scheme used in searching for the wireless power transmitter in step 1704 (S1712). For example, if the wirelessly charged battery fails to discover a wireless power transmitter of the electromagnetic resonance scheme, then the wirelessly charged battery may attempt to search for a wireless power transmitter of the electromagnetic induction scheme, but embodiments are not limited thereto. It should be noted that the operations for searching for a wireless power transmitter may be performed in reverse order.

In step 1703, if B_level is higher than or equal to B_rx_mode and is higher than a predetermined transmitter mode threshold B_tx_mode, the wirelessly charged battery may switch to the transmitter mode to perform search for a wireless power receiver (S1709). Here, search for the wireless power receiver may be performed in a similar manner to search for a wireless power transmitter. That is, a control operation may be performed such that, when the wirelessly charged battery fails to discover a wireless power receiver of the electromagnetic resonance scheme, a wireless power receiver of the electromagnetic induction scheme is searched for. However, embodiments are not limited thereto. It should be noted that search for a wireless power receiver may be performed in reverse order.

When a wireless power receiver is sensed, the wirelessly charged battery may transmit power signal to the sensed wireless power receiver using the power of the charged battery (S1710 and S1711).

In step 1709, if search for the wireless power receiver fails, the wirelessly charged battery may return to step 1704, namely may switch to the receiver mode to perform search for a wireless power transmitter.

In step 1708, if B_level is lower than or equal to B_tx_mode, the wirelessly charged battery may return to step 1704 to perform search for a wireless power transmitter.

As illustrated in FIG. 17, the wirelessly charged battery according to one embodiment of the present disclosure may adaptively change the operation mode based on the current battery charging level to maintain the battery charging level of an adjacent wireless power receiver or (and) the battery charging level of the wirelessly charged battery so as to be higher than or equal to a predetermined threshold.

Another embodiment of the present disclosure may provide a computer-readable recording medium on which a program for executing a wireless power reception method and a wireless power transmission/reception method for the wirelessly charged battery described above is recorded.

In this case, the computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The present disclosure relates to a wireless power transmission technology, and may be applied to a wirelessly charged battery capable of supplying power to an electronic device and a wireless power reception apparatus to which a wireless charging control method using the wirelessly charged battery is applied.

1. A wireless charging control method in a wirelessly charged battery mountable in an electronic device, the method comprising:
calculating a battery charging level of the wirelessly charged battery;
switching an operation mode of the wirelessly charged battery to a receiver mode when the calculated battery charging level is lower than a predetermined receiver mode threshold;
searching for a wireless power transmission apparatus when the operation mode is switched to the receiver mode; and
receiving a power signal from the discovered wireless power transmission apparatus and charging the battery.

2. The method according to claim 1, wherein the calculating of the battery charging level comprises:
measuring a battery output voltage intensity of the wirelessly charged battery; and
calculating the battery charging level based on the measured battery output voltage intensity.

3. The method according to claim 1, wherein the search for the wireless power transmission apparatus comprises:
searching for a wireless power transmission apparatus supporting a first wireless power transmission scheme; and
searching for a wireless power transmission apparatus supporting a second wireless power transmission scheme when the search for the wireless power transmission apparatus supporting the first wireless power transmission scheme fails.

4. The method according to claim 3, wherein each of the first wireless power transmission scheme and the second wireless power transmission scheme is one of an electromagnetic resonance scheme and an electromagnetic induction scheme.

5. The method according to claim 1, further comprising:
switching the operation mode of the wirelessly charged battery from the receiver mode to a transmitter mode when the battery charging level calculated in the receiver mode exceeds a predetermined transmitter mode threshold.

6. The method according to claim 5, further comprising:
searching for a wireless power reception apparatus when the operation mode is switched to the transmitter mode; and
transmitting a power signal to the discovered wireless power reception apparatus using power charged in the battery.

7. The method according to claim 6, further comprising:
returning to the search for the wireless power transmission apparatus when the search for the wireless power reception apparatus fails in the transmitter mode.

8. The method according to claim 6, wherein, when power greater than or equal to a predetermined reference value is supplied to the electronic device in the transmitter mode, the operation mode is switched to the receiver mode.

9. The method according to claim 1, further comprising:
collecting information about a battery charging level of an adjacent wirelessly charged battery connected in parallel or in series with the wirelessly charged battery,
wherein, when the battery charging level of the wirelessly charged battery exceeds the battery charging level of the adjacent wirelessly charged battery, the operation mode is switched to the transmitter mode, and the adjacent wirelessly charged battery is charged using power charged in the battery.

10. The method according to claim 1, wherein the calculating of the battery charging level comprises:
measuring a temperature of a resistance element connected to a positive terminal of the wirelessly charged battery; and
calculating the battery charging level based on the measured temperature.

11. A wirelessly charged battery mountable in an electronic device, comprising:
a core having magnetism;
a coil surrounding an outer periphery of the core;
a wireless power reception unit configured to convert alternating current (AC) power received through the coil into direct current (DC) power and supply the DC power to a load;
a sensing unit configured to measure an output voltage intensity of the load; and
a controller configured to calculate a battery charging level based on the output voltage intensity of the load and to switch an operation mode of the wirelessly charged battery to a receiver mode and search for a wireless power transmission apparatus to receive a power signal when the calculated battery charging level is lower than a predetermined receiver mode threshold.

12. The wirelessly charged battery according to claim 11, wherein the wirelessly charged battery is connected in parallel or in series with at least one slave wirelessly charged battery through a predetermined connection means, wherein the controller communicates with the discovered wireless power transmission apparatus as a master to control the at least one slave wirelessly charged battery to be wirelessly charged.

13. The wirelessly charged battery according to claim 11, wherein, when a search for a wireless power transmission apparatus supporting a first wireless power transmission scheme fails, the controller searches for a wireless power transmission apparatus supporting a second wireless power transmission scheme.

14. The wirelessly charged battery according to claim 13, wherein each of the first wireless power transmission scheme and the second wireless power transmission scheme is one of an electromagnetic resonance scheme and an electromagnetic induction scheme.

15. The wirelessly charged battery according to claim 11, wherein, when the battery charging level calculated in the receiver mode exceeds a predetermined transmitter mode threshold, the controller switches the operation mode of the wirelessly charged battery from the receiver mode to a transmitter mode.

16. The wirelessly charged battery according to claim 15, further comprising:
a wireless power transmission unit configured to transmit a power signal under control of the controller in the transmitter mode,
wherein, when the operation mode is switched to the transmitter mode, the controller searches for a wireless power reception apparatus, and controls power charged in the battery to be transmitted to the discovered wireless power reception apparatus through the wireless power transmission unit.

17. The wirelessly charged battery according to claim 16, wherein, when the search for the wireless power reception apparatus fails in the transmitter mode, the controller switches the operation mode to the receiver mode to search for the wireless power transmission apparatus.

18. The wirelessly charged battery according to claim 16, further comprising:
a power terminal for supplying power charged in the load to the electronic device,
wherein, when an intensity of the power supplied to the electronic device in the transmitter mode is greater than or equal to a predetermined reference value, the controller switches the operation mode to the receiver mode.

19. The wirelessly charged battery according to claim 11, further comprising:
a communication unit configured to collect information about a battery charging level of an adjacent wirelessly charged battery connected in parallel or in series with the wirelessly charged battery,
wherein, when the battery charging level of the wirelessly charged battery exceeds the battery charging level of the adjacent wirelessly charged battery, the controller switches the operation mode to the transmitter mode, and controls the adjacent wirelessly charged battery to be charged using power charged in the battery.

20. The wirelessly charged battery according to claim 11, wherein the sensing unit comprises a means to measure a temperature of a resistance element connected to a positive terminal of the load,
wherein the controller calculates the battery charging level based on the measured temperature.

21. (canceled)

22. (canceled)
